(19) United States
(12) Patent Application Publication
(10) Pub. No.: US 2026/0346280 A1
(43) Pub. Date: Nov. 5, 2026

(54) Impulse sprinkler with system for adjusting the swinging angle and relative method

(71) Applicant: Komet Austria GmbH, Lienz (AT)

(72) Inventor: Arno Drechsel, Lienz (AT)

(21) Appl. No.: 19/130,901

(22) PCT Filed: Nov. 16, 2023
(86) PCT No.: PCT/IB2023/061595

§ 371 Date: May 16, 2025

(30) Foreign Application Priority Data
Nov. 22, 2022 (IT) 102022000024000

(51) Int. Cl. B05B 3/14; A01G 25/16; B05B 12/00; B05B 13/00; G01D 5/14

(52) U.S. Cl. CPC B05B 3/14; A01G 25/16; B05B 12/004; B05B 13/005; G01D 5/142

(57) ABSTRACT

An impulse sprinkler with an adjustment system for adjusting the swinging angle includes a spout tube connected to a pressurized water supply line for generating a jet, a joint rotatable around a substantially vertical axis, and an oscillating arm driven by the jet to determine the automatic rotation of the spout tube with periodic reversal of the direction of rotation. The adjustment system includes a linear actuator selectively movable between two end positions to automatically control the direction of rotation of the spout tube. A method for adjusting the swinging angle in the impulse sprinkler is also disclosed.

### FIELD OF THE INVENTION

The present invention generally finds application in the technical field of irrigation systems for farming and industrial purposes and it particularly relates to an impulse sprinkler with an adjusting system of the swinging angle.

The invention also relates to a method for adjusting the swinging angle of an impulse sprinkler.

### BACKGROUND ART

Impulse sprinklers are known for farming and/or industrial purposes connected to a pressurized liquid supply line and adapted to distribute a jet of such liquid on a land portion to be irrigated.

Impulse sprinklers are generally rotatable around their vertical axis and comprise a spout tube for a pressurized liquid jet and end stroke or stop elements adapted to delimit an angular sector corresponding to an angular portion of the land to be irrigated.

Furthermore, these sprinklers comprise an oscillating arm driven by the liquid jet exiting from the spout tube and adapted to promote the rotation of the spout tube and a reversing lever coupled to the oscillating arm adapted to alternatively interact with one of the two stops to periodically reverse the direction of rotation of the spout tube within a swinging angle defined by the pair of end stroke elements.

This type of impulse sprinklers can be installed on fixed-type systems, but it is typically installed on board a self-propelled trolley, adapted to be moved over the land to be irrigated in a generally straight direction in such a manner to wet a broader surface area of land.

Therefore, with respect to a pre-established angular reference position, commonly referred to as zero position, the spout tube moved in the direction opposite to the zero position can cover a predetermined swinging angle by rotating symmetrically or asymmetrically between a first negative angle and a second positive angle with respect to the zero position.

A first drawback of such sprinklers lies in the fact that they do not allow to change the angular sector covered by the spout tube during irrigation.

As a matter of fact, at the end of each irrigation cycle, the user must manually change the position of the stops and actuate the sprinkler again to irrigate an angular sector different from the first one.

With the purpose of overcoming these drawbacks, systems have been developed for the automatic adjustment of the swinging angle of the spout tube of a sprinkler which allow to automatically change the irrigated angular sector thereby avoiding the action of the operator or interrupting the operation of the sprinkler.

EP3095525 discloses a sprinkler of the type described above which has a trolley connected to a liquid supply source, a dispensing mouth integrally joined with the trolley and a spout tube provided with an oscillating arm connected to the dispensing mouth rotating around a vertical axis.

The sprinkler further comprises an intermediate tubular support, coaxial to the vertical axis, consisting of a lower portion integrally joined with dispensing mouth and an upper portion which supports the spout tube. The upper portion and lower portion are rotatably coupled around the vertical axis and comprise a toothed disc and a pair of limit switches for adjusting the angular irrigation sector.

The lower portion comprises drive means adapted to drive the toothed disc in rotation around the vertical axis to change the orientation of the end-of-stroke of the upper portion to adjust the swinging angle of the sprinkler.

Although it uses a system for the automatic adjustment of the swinging angle which allows a rotation, even asymmetrical, of the spout tube with respect to the zero position, this prior art sprinkler reveals a first drawback which lies in the fact that the adjustment system is rather complex.

Furthermore, the drive means of the adjustment system are powered by an electrical power source and, if there is none, the sprinkler cannot operate normally anymore, resulting in impossibility to irrigate the land properly.

Still, another drawback of such solution lies in the fact that the drive means are always powered, resulting in an increase in consumption, even when using a battery.

Last but not least, the drawback lies in the fact that the sprinkler has no automatic safety system adapted to intervene if the swinging or tilting angle of the self-propelled trolley is exceeded, so as to avoid irrigating unintended surfaces.

Lastly, the prior art sprinklers provided with a system for the automatic adjustment of the swinging angle cannot be used manually in the event of a malfunction of the system.

### Technical Problem

In the light of the prior art, the technical problem addressed by the present invention is to allow an adjustment of the swinging angle of an impulse sprinkler both manually and automatically.

### SUMMARY OF THE INVENTION

The object of the present invention is to solve the aforementioned problem by providing an impulse sprinkler with a system for adjusting the swinging angle which is highly effective and cost-effective.

A further object of the present invention is to provide an impulse sprinkler and an adjustment method of the type described above which allows an extremely simple setting and programming.

A particular object of the present invention is to provide an impulse sprinkler of the type indicated above which allows to operate both automatically and manually.

Another object of the present invention is to provide an impulse sprinkler of the type indicated above which has an automatic safety system adapted to act should the set swinging angle be exceeded.

A further object of the present invention is to provide an impulse sprinkler of the type indicated above in which the system for adjusting the swinging angle allows to consume energy only when reversing the spout tube.

Another object of the present invention is to provide an impulse sprinkler of the type described above which has small overall dimensions.

The objects mentioned above and others which will be more apparent hereinafter, are achieved by an impulse sprinkler with a system for adjusting the swinging angle, according to claim 1, wherein the sprinkler comprises a spout tube connected to a pressurized water supply line for generating a jet, a joint rotatable around a substantially vertical axis and an oscillating arm driven by the jet to determine the automatic rotation of the spout tube with periodic reversal of the direction of rotation.

The system for the adjustment of the swinging angle of the impulse sprinkler comprises at least one actuator member selectively movable between two end positions to automatically control the direction of rotation of the spout tube.

Electronic control means are further provided which are connected to the actuator member so as to allow the control thereof and the selective movement between the end positions.

The electronic control means further comprise at least one electronic compass adapted to determine the instantaneous position of said spout tube within the angular irrigation sector defined by the set swinging angle.

Furthermore, an end of the linear actuator interacts with an electronic limit switch positioned close to the centreline of the end positions, which is adapted to interrupt the rotation of the spout tube in case of malfunction.

Suitably, a removable connection element is provided which has a first end connected to the actuator member and a second end connected to the oscillating arm by means of a cross lever.

Thanks to such combination of features it is possible to obtain a sprinkler with control and adjustment of the swinging angles and with a safety system should the sprinkler exceed the angular sector defined by the swinging angle.

Furthermore, the adjustment system may be selectively de-coupled to allow both a manual and automatic adjustment of the swinging angle.

The invention also relates to a method for adjusting the swinging angle in an impulse sprinkler, according to claim 13.

Advantageous embodiments of the invention are attained according to the dependent claims.

### BRIEF DESCRIPTION OF THE DRAWINGS

Further characteristics and advantages of the invention will be more apparent in the light of the detailed description of a preferred but not exclusive embodiment of an impulse sprinkler like the one mentioned above, shown by way of non-limiting example with reference to the drawings below, wherein:

FIG. 1 is a perspective view of the impulse sprinkler according to the invention;

FIGS. 2 and 3A are respectively a cross-sectional lateral view and an exploded perspective view of the of the sprinkler of FIG. 1;

FIG. 3B is a perspective view of an alternative embodiment of a detail of the sprinkler of FIG. 3A;

FIGS. 4A and 4B are an enlarged view of a detail of the sprinkler of FIG. 2 in two different operating configurations;

FIGS. 5A-5C are a schematic view of the operation of the detail of the sprinkler of FIG. 4 in three different operating configurations;

FIG. 6 is a first operational diagram of the sprinkler of FIG. 1;

FIG. 7 is a second operational diagram of the sprinkler FIG. 1.

### DETAILED DESCRIPTION OF PREFERRED EMBODIMENTS

With reference to the figures, there is shown an impulse sprinkler, globally identified with the reference numeral 1, which is configured to distribute a liquid, for example water, on a determined surface area of the land to be irrigated.

In a per se known manner, the sprinkler 1 comprises a spout tube 2 defining and irrigation axis R and connected to a pressurized water supply line for generating a jet, not shown in the figures, and a joint 3 rotatable around a substantially vertical axis Z.

Advantageously, the joint 3 comprises a fixed part 4 coupled to the liquid supply line and a rotatable part 5 coupled to the spout tube 2 to promote the rotation thereof.

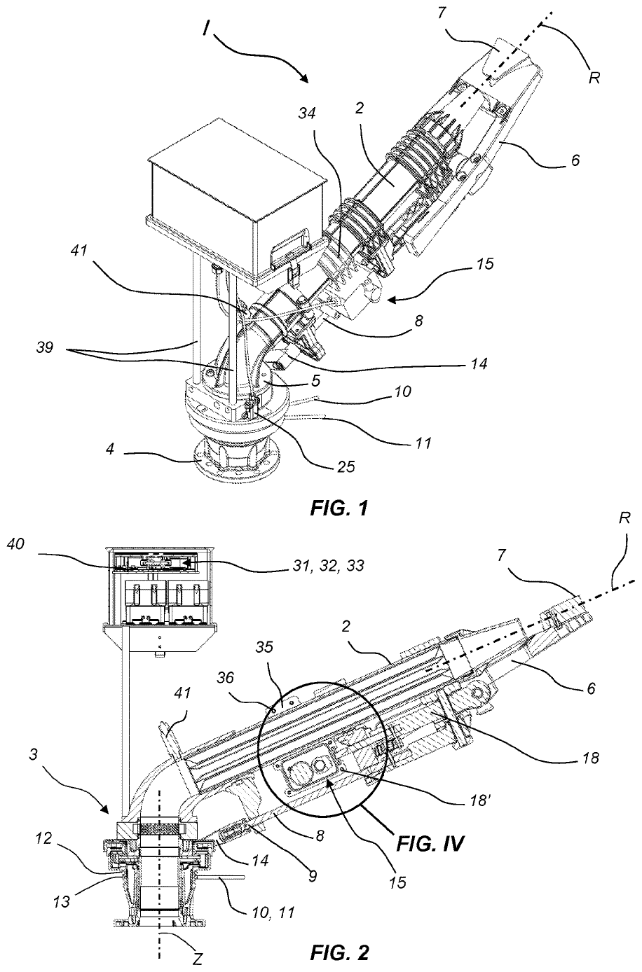

In an embodiment, the sprinkle 1 comprises an oscillating arm 6 driven by the pressurized liquid jet to determine the automatic rotation of the spout tube 2 with periodic reversal of the direction of rotation, as better shown in FIGS. 1-3A.

In particular, the oscillating arm 6 comprises a deflector 7 adapted to interfere with liquid jet flowing out from the spout tube 2 so as to induce the rotation thereof, as well known to the person skilled in the art, and a rod 8 having an end 9 facing towards the joint 3 of the sprinkler 1.

The sprinkler 1 comprises a pair of mechanical limit switches 10, 11 which can be associated with the fixed part 4 of the joint 3 in predetermined angular positions on a perpendicular plane with respect to the vertical rotation axis Z, so as to delimit an angular irrigation sector W corresponding to a desired swinging angle α.

As better shown in FIG. 2, each of the mechanical limit switches 10, 11 is formed on a respective annular element 12, 13 coupled to the fixed part 4 of the joint 3 and which protrudes radially outwards.

In a per se known manner, the annular elements 12, 13 are mutually rotatable to change the angular position of the mechanical limit switches 10, 11 and therefore the width of the swinging angle α of the irrigation sector W.

The sprinkler 1 comprises a reversing lever 14 which can be operatively coupled to the oscillating arm 6, in particular to the end 9 of the rod 8 facing towards the joint 4.

The reversing lever 14 is adapted to interact with the pair of mechanical limit switches 10, 11 during the rotation of the spout tube 2 so as to reverse the direction of rotation within the irrigation sector W.

In particular, the contact of the reversing lever 14 with a respective mechanical limit switch 10 will cause the oscillation of the oscillating arm 6 according to a determined clockwise-anticlockwise direction of rotation. The movement of the oscillating arm 6 will promote the rotation of the spout tube 2 around the vertical axis Z in the two directions of rotation.

Furthermore, the contact of the reversing lever 14 with the other mechanical limit switch 11 will cause the oscillation of the oscillating arm 6 in the opposite direction and the resulting reversal of the direction of rotation of the spout tube 2 within the irrigation sector W.

Therefore, following the interaction with one of the two mechanical limit switches 10, 11, the reversing lever 14 changes, through the operatively associated rod 8, the position of the deflector 7 so that the latter interferes with the liquid jet on the opposite side, therefore changing the direction of rotation of the spout tube 2.

It should be observed that the sprinkler 1 described heretofore, provided with the reversing lever 14 on the rod 8 interacting with the two mechanical limit switches 10, 11 and therefore, it has the same characteristics as the conventional sprinkler.

Advantageously, the impulse sprinkler 1 comprises a system 15 for the automatic adjustment of the swinging angle α which will be described hereinafter.

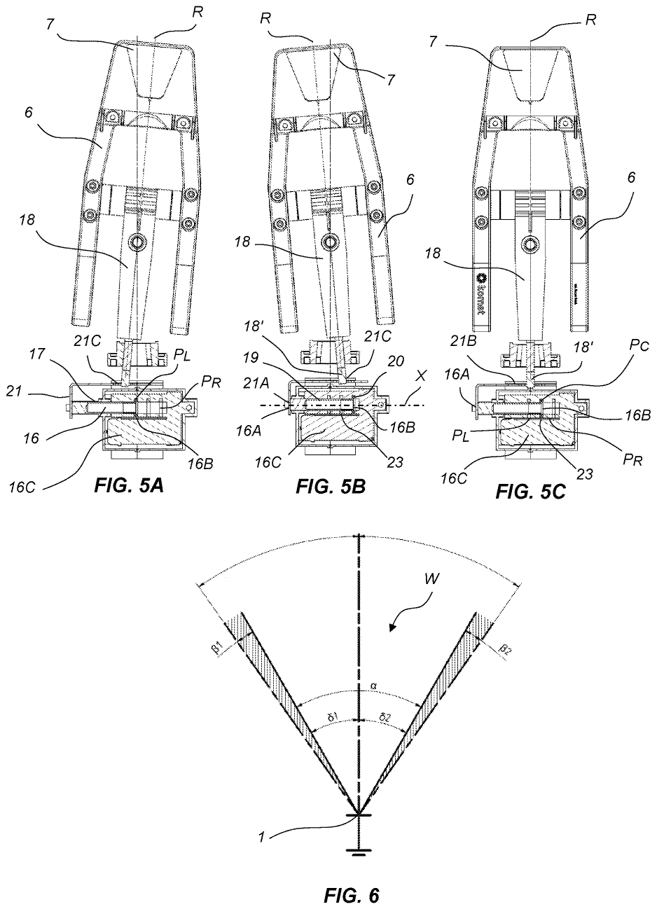

As better schematised in FIGS. 5A-5B, the adjustment system 15 comprises at least one actuator member 16 selectively movable between two end positions P_{L}, P_{R}, to automatically control the direction of rotation of the spout tube 2.

Preferably, the actuator member 16 is housed in a chamber 17 which defines an axis X substantially orthogonal to the rotation axis Z and to the irrigation axis R of the spout tube 2.

Furthermore, the actuator member 16 comprises a first end 16A which is operatively coupled with the oscillating arm 6 using a cross lever 18 and a second end 16B which interacts with at least two electronic limit switches 19, 20 positioned in the chamber 17 at the end positions PL, PR.

Therefore, the actuator member 16 may be seen as the stem of a hydraulic plunger, which can be selectively moved within a cylinder, defined by the chamber 17, between two minimum and maximum extension positions defined by the end positions P_{L}, P_{R}.

As better shown in FIG. 5, the first end 16A of the actuator member 16 is operatively connected to the cross lever 18 using a connection element 21, so that the movement of the actuator 16 along the axis X of the chamber 17 determines the movement of the cross lever 18 and therefore of the oscillating arm 6.

In an embodiment, the connection element 21 is a shaped plate provided with a first connection element 21A coupled with the first end 16A of the actuator member 16 and a second connection element 21B coupled with the cross lever 18, as betters shown in FIGS. 2, 4A-5.

In particular, the second connection element 21B has a through hole 21C adapted to house the substantially cylindrical end portion 18′ of the cross lever 18.

In an embodiment, the adjustment system 15 of the sprinkler 1 comprises electronic control means 22 connected to the actuator member 16 so as to allow the actuation thereof and the selective movement between the end positions P_{L}, P_{R} and, therefore, establish the direction of rotation of the spout tube 2 of the sprinkler 1.

In an embodiment, the control means 22 are electrically connected to the actuator member 16 through a linear motor 16C or through electrical and/or magnetic movement means of the equivalent type.

Therefore, thanks to the connection to the actuator member 16 with the oscillating arm 6, when the electronic control means 22 control the position of the actuator 16 between the end positions P_{L}, P_{R}, the connection element 21 changes, by means of the cross lever 18, the position of the deflector 7 so that the latter interferes with the liquid jet on an opposite side, changing the direction of rotation of the spout tube 2.

Obviously, during this type of automatic operation, the reversing lever 14 is positioned so as not to interfere with the mechanical limit switches 10, 11, for example laterally as shown in FIGS. 1-2, and so as to allow the spout tube 2 to rotate freely by 360°.

FIG. 5A shows the adjustment system 15 in which the actuator member 16 is in the end position P_{L} and the spout tube 2 rotates in the clockwise direction seen from above.

FIG. 5B shows the adjustment system 15 in which the actuator member 16 instead is in the end position PR and the spout tube 2 rotates in the anticlockwise direction seen from above.

The second end 16B of the actuator member 16 interacts with a third electronic limit switch 23 positioned close to the centreline P_{C} of the end positions P_{L}, P_{R}, as better shown in FIG. 5C.

As a matter of fact, in case of a malfunction or error of any type, the electronic control means 22 allow to position the second end 16B in the centreline position P_{C} so that the oscillating arm 6 continues to oscillate without the waterjet causing a lateral movement of the deflector 7.

Besides determining the position of the actuator 16 within the chamber 17, the control means 22 are adapted to measure the swinging angle α.

To this end, the electronic control means 22 comprise at least one electronic compass 24 adapted to detect the instantaneous position of the spout tube 2 within the angular irrigation sector W.

In an embodiment, the electronic compass 24 is positioned in correspondence with the vertical axis Z so as to accurately measure the value of the angle of rotation of the spout tube 2 around the axis Z.

Furthermore, the electronic control means 22 may comprise at least one Hall sensor 25′ and/or one encoder 25″ also adapted to detect the instantaneous position of the spout tube 2 within the angular irrigation sector W and, if necessary, correct any angular errors detected by the electronic compass 24.

It should be borne in mind that the Hall sensor, or a Hall effect sensor, is a transduction device adapted to detect a quantity and transduce it into an electric voltage when a magnetic field is present, more precisely, for generating an electric voltage with value proportional to the value of the magnetic field.

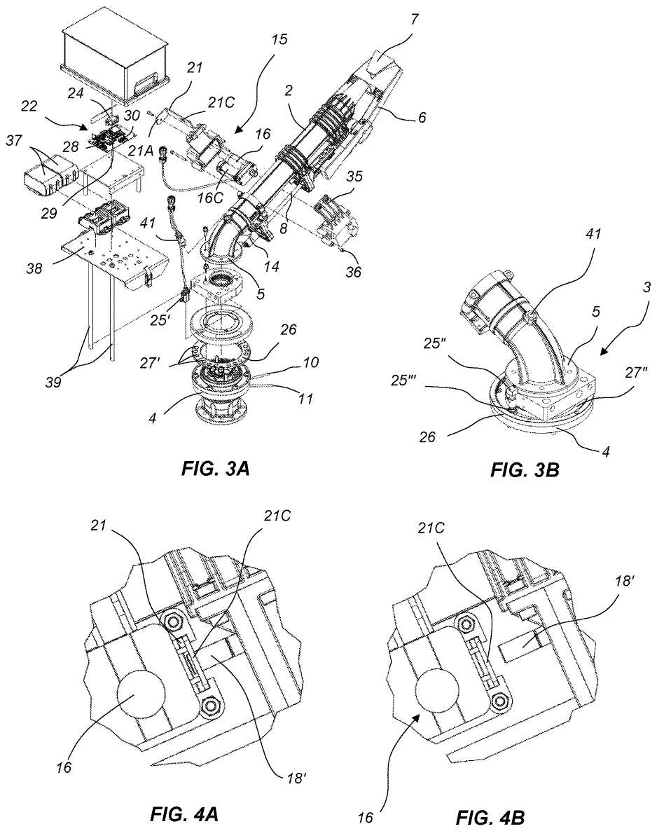

As better shown in FIG. 3A, the Hall sensor 25′ is installed into the rotatable part 5 of the joint 3 and it interacts with a ring 26 positioned at the fixed part 4 of the joint 3 and provided with at least one magnet 27′.

Preferably, on the ring 26 there are provided a plurality of magnets 27′ arranged radially.

Therefore, the Hall sensor 25′ is capable of instantaneously measuring the magnetic field produced by the magnets 27′ and therefore the instantaneous position of the irrigation axis R of the spout tube 2.

As better shown in FIG. 3B, which shows the rotary joint 3 provided with the encoder 25″, the latter is installed in the rotatable part 5 of the joint 3 and it comprises a gearwheel 25″ interacting with a toothed surface 27″ of a ring 26 positioned at the fixed part 4 of the joint 3.

Therefore, the encoder 25″ is capable of instantaneously measuring the position of the ring 26 with respect to the encoder 25″ and therefore the instantaneous position of the irrigation axis R of the spout tube 2.

Hence, the electronic compass 24 and/or the Hall sensor 25′ and/or the encoder 25″ allow to measure the actual rotation of the rotatable part 5, and therefore of the spout tube 2, with respect to the fixed part 4 of the joint 3.

In an embodiment, the electronic control means 22 comprise an electronic memory unit 28 adapted to store the value of at least one swinging angle α which can be set by the user or by an irrigation map.

The information stored in the memory unit 28 may be transferred by the user through an RFD, WiFi, Bluetooth or microSD interface module, or through LTE, UMTS or GSM networks in a manner per se known to the person skilled in the art.

By way of example, the irrigation map and/or the swinging angle α may be uploaded into the electronic memory unit 28 by the operator through a web application provided to the user.

Furthermore, the electronic control means 22 comprise at least one central microprocessor unit 29 and a GPS sensor 30.

The electronic control means 22 may further comprise a group of sensors 31, 32, 33 adapted to determine the instantaneous position of the spout tube 2 with greater precision.

In particular, the group of sensors may comprise one or more sensors selected from the group including an accelerometer 31, a gyroscope 32 and a magnetometer 33.

Preferably, the accelerometer 31, the gyroscope 32 and the magnetometer 33 are of the three-axe type and they may be installed in a single inertial measurement electronic component, configured to detect the orientation, the instantaneous direction of the sprinkler and the potential tipping over thereof.

In other words, the inertial measurement electronic component is configured to calculate the yaw, the pitch and the roll of the spout tube 2.

Therefore, if an operator stores the swinging angle α on the memory unit 28, the microprocessor 29 of the control means 22 controls the selective position of the actuator member 16 and therefore the direction of rotation of the spout tube 2 within the irrigation sector W defined by the swinging angle α.

When the accelerometer 31, the gyroscope 32 and the magnetometer 33 detect an excessive inclination of the irrigation axis R of the spout tube 2 for example due to an even partial tipping over of the sprinkler 1, electronic control means 22 position the second end 16B of the actuator member 16 at the centreline position P_{C} interrupting the rotation of the spout tube 2.

Similarly, when the electronic compass 24 and/or the Hall sensor 25′ and/or the encoder 25″ detect a position of the spout tube 2 different from the desired one or externally to the set swinging angle α, the electronic control means 22 position the second end 16B of the actuator member 16 at the centreline position Pc interrupting the rotation of the spout tube 2.

FIG. 6 shows that the interruption of the rotation of the spout tube 2 around the vertical axis Z may occur when the position of the irrigation axis R of the spout tube 2 is in the angular sectors defined by the operating tolerance angles β₁ or β₂ that is in the angular sectors different from the angular sector W defined by the set swinging angle α.

Suitably, the control means 22 may be connected to the pressurized water supply line to shut off the flow thereof when the third electronic limit switch 23 is active.

In an embodiment, the connection element 21 is removable so as to allow the sprinkler 1 to operate selectively between an automatic configuration, wherein the swinging is controlled by the electronic control means 22 and by the movable actuator member 16 and a mechanical configuration, wherein the swinging is controlled by the rod 9 and the mechanical limit switches 10, 11.

To this end, the actuator member 16 is positioned on the spout tube 2 by means of a connection system 34 which can be removed from the spout tube 2 and which can be moved away from the oscillating arm 6 to disconnect the actuator member 16 from the oscillating arm 6, as shown in FIGS. 3A, 4A and 4B.

In an embodiment, the connection system 34 comprises a pair of coupling flanges 35 mutually couplable by connection means 36 and which can be engaged to the spout tube 2.

Therefore, in order to move from the automatic configuration to the mechanical configuration, it will be sufficient to move the coupling flanges 35 away from the oscillating arm 6 sliding them along the spout tube 2 and removing the end portion 18′ of the cross lever 18 from the hole 21C of the connection element 21.

Furthermore, the reversing lever 14 shall be rotated so as to be able to interact with the mechanical limit switches 10, 11.

In an embodiment, the actuator member 16 and the electronic control means 22 form an adjustment kit which can be selectively coupled to an impulse sprinkler so as to allow it to operate selectively between a mechanical configuration and an automatic configuration for adjusting the swinging angle α.

Therefore, in case of a malfunction of the control means 22 of the adjustment system 15 or of a component thereof, the operation of the sprinkler 1 can be converted conventionally wherein the swinging is controlled by the reversing lever 14 on the rod 9 and the mechanical limit switches 10, 11.

In an embodiment, each electrical and/or electronic component of the adjustment system 15 is power-supplied by an electrical power source.

By way of non-limiting example, the electrical power source may comprise at least one battery 37 of the rechargeable and replaceable type.

Preferably, the electronic compass 24, the plurality of sensors 31, 32, 33, the battery 37 may be installed on a platform 38 supported by support means 39 and positioned above the joint 3, as better shown in FIGS. 1-3A.

The platform 38 may be adapted to contain an electronic board 40 adapted to contain the microprocessor 29, the memory unit 28, the GPS sensor 30 and the inertial measurement electronic component comprising the accelerometer 31, the gyroscope 32 and/or the magnetometer 33.

Furthermore, an antenna for the wireless communication with the control means 22, a temperature sensor or other electronic devices useful for the operation of the adjustment system 15, not shown in the figures, may be installed on the electronic board 40.

In an embodiment, the sprinkler 1 may be monitored constantly during the operation thereof by connecting it to a web server by means of an antenna so as to allow the instantaneous display of the rotation angle, the status of all sensors and the control or change of all settable irrigation angles.

Furthermore, the control means 22 may also comprise a pressure sensor 41 which is fluidically connected to the joint 3 or to a hole obtained on the spout tube 2, to control the actuation of the adjustment system 15 upon reaching a determined pressure of the irrigation water.

In an embodiment, the control means 22 may be connected to an anemometer or similar device (not shown in the figures) for the detection of speed and/or direction of the wind.

Depending on the strength of the wind detected, the control means 22 may change the swinging angle α so as to compensate for potential deviations in the pressurized liquid jet due to the wind.

Furthermore, should the strength of the wind be excessive, in order to avoid potential damage to roads, people or property due to the deviation of the jet, the electronic control means 22 will position the second end 16B of the actuator member 16 at the centreline position P_{C} therefore interrupting the rotation of the spout tube 2.

In such operative configuration, the actuator member 16 is in axis with the spout tube 2 and the electronic control means 22 may simultaneously send an alarm signal to shut off the flow of the pressurized water and interrupt the irrigation.

Simultaneously, the sending of the irrigation shut off alarm an alarm signal may also be sent to the user.

In an embodiment, the sprinkler 1 may be installed on a self-propelled trolley, moved along a predetermined generally straight path, which defines a virtual line Y along the land to be irrigated.

Generally, the spout tube 2 is pointed towards the direction opposite to the path predetermined by the virtual movement line Y so that the self-propelled trolley can move along a dry land.

Operatively, when the trolley and the sprinkler 1 are placed on the field to be irrigated, the GPS sensor 30 memorises the initial Y₁ and final Y₂ geographical position of the virtual movement line Y.

In this case, the distance between the geographical positions Y₁ and Y₂ of the virtual movement line Y corresponds to the length of the of the unrolled irrigation hose which connects the water supply line to the sprinkler 1.

Furthermore, the user positions the irrigation axis R of the spout tube 2 so as to be aligned with the virtual movement line Y and the control means 22 memorise such virtual line Y as “zero position” of the swinging angle α.

Such position zero may correspond to a line positioned at the end of the irrigation sector W defined by the swinging angle α or to any line positioned within the angular sector W and defined by a pair of portions of irrigation angles δ₁ and δ₂, to the right and to the left with respect to the zero position, even with different value with respect to each other, but whose sum is equal to the swinging angle α.

At this point, the user may set the value of the at least one swinging angle α or of the angles δ₁ and δ₂ in the electronic memory unit 28 depending on the geographical position of the sprinkler 1 along the virtual movement line Y from the initial position Y₁ to the final position Y₂.

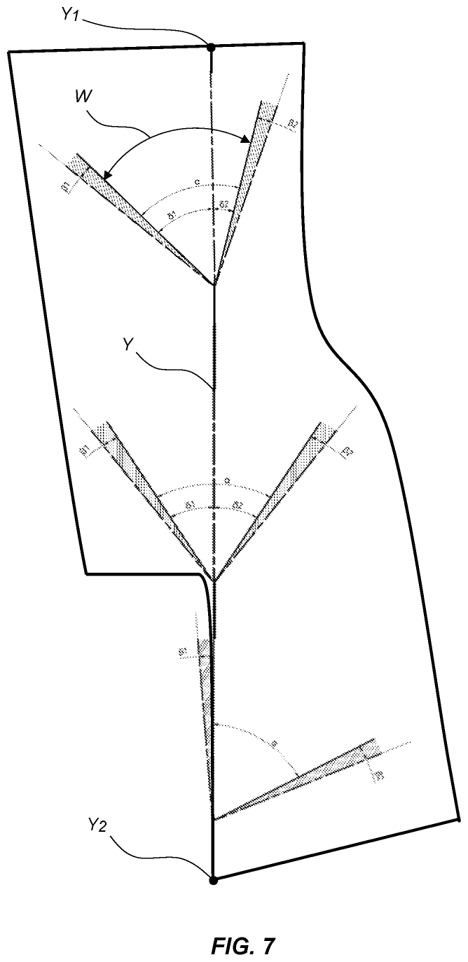

This will allow to upload different irrigation programmes with several swinging angles ≢0 into the electronic memory unit 28 so as to allow the irrigation of even uneven land, as shown in FIG. 7.

The central microprocessor unit 29 of the sprinkler 1 may be connected through GSM, or Lora network, or a proprietary communication module of the user, or through IOT connections to a web platform of the customer.

Such platform will be configured so as to control, through a PC positioned in a remote geographical location with respect to that of the field to be irrigated, various irrigation components and machines that form an irrigation system such as for example pumps, various irrigation systems such as center pivot systems, self-propelling trolleys, fixed systems, valves and others.

Furthermore, the platform comprises the option of mapping the geometrical configuration of the land to be irrigated, store the irrigations carried out during an irrigation season and measure the amounts of water used.

Therefore, the computer programme installed in the microprocessor 29 of the sprinkler 1 may be configured so as to control the swinging angle α so as the latter always remains inserted into the mapped surface.

According to a further aspect of the invention, there is provided a method for adjusting the swinging angle α in an impulse sprinkler 1 of the type described above.

The method according to the invention provides a first step a) of storing at least one swinging angle α in the electronic control means 22 and a step b) of supplying the sprinkler 1 with pressurized water.

Subsequently, there are provided the steps c) of positioning the actuator member 16 in a first end position P_{L} of the chamber 17 to control the rotation of the spout tube 2 in a first direction of rotation, for example clockwise as shown in FIG. 5A.

Furthermore, there is provided a step d) of monitoring the instantaneous position and the direction of rotation of the spout tube 2 in the angular irrigation sector W defined by the swinging angle α by means of the electronic control means 22.

Subsequently, when the position of the spout tube 2 monitored in step d) reaches the swinging angle α, the method comprising a step e) of positioning the actuator member 16 in a second end position P_{R} of the chamber 17, opposite to the first P_{L}, to control the rotation of the spout tube 2 in a second direction of rotation opposite to the first, for example anticlockwise, as shown in FIG. 5B.

Lastly, in the monitoring step d), when there is detected an instantaneous position of the spout tube 2 in an angle greater than the swinging angle α, for example in the angular sectors defined by the operating tolerance angles β₁ or β₂, and then there is detected a swinging angle α+β₁ or α+β₂ greater than the one set, in the method according to the invention there is provided a step f) of positioning the actuator member 16 at the centreline P_{C} of the end positions P_{L}, P_{R} so as to interrupt the rotation of the spout tube around the vertical axis Z, as better shown in FIGS. 5C and 6.

Furthermore, subsequently to the positioning step f) there is provided a step g) of shutting off the flow of pressurized water to shut off the irrigation.

Alternatively, the shutting off step g) may be provided when in the monitoring step d) there is detected an instantaneous position of the spout tube 2 having an excessive tilt, measured by the accelerometer 31, the gyroscope 32 and/or the magnetometer 33, for example due to an even partial tipping over of the sprinkler 1.

Obviously, the shutting off step g) may comprise the sending an alarm signal to the user.

In the light of the above, it is clear that the sprinkler and the adjustment method according to the invention achieve the pre-established objects and in particular they allow both a manual and automatic adjustment of the swinging angle.

The sprinkler and the method according to the invention are susceptible to numerous modifications and variants all falling within the inventive concept outlined in the attached claims.

Although sprinkler and method have been described with particular reference to the attached figures, the reference numerals used in the description and in the claims are meant for improving the intelligibility of the invention and do not limit the claimed scope of protection in any manner whatsoever.

### Industrial Applicability

The present invention can be applied at industrial level because it can be produced in an industrial scale by industries belonging to the field of irrigation systems for farming and industrial purposes.

The invention claimed is:

1. An impulse sprinkler (1) with a system (15) for adjusting a swinging angle (α), wherein the impulse sprinkler (1) comprises:
a spout tube (2) connected to a pressurized water supply line for generating a jet;
a joint (3) rotatable around a substantially vertical axis (Z); and
an oscillating arm (6) driven by the jet to determine an automatic rotation of the spout tube (2) with periodic reversal of a direction of rotation;
wherein the system (15) for the adjusting the swinging angle (α) comprises at least one actuator (16) selectively movable between two end positions (PL, PR) to automatically control the direction of rotation of said spout tube (2); and
wherein said actuator (16) comprises a first end (16A) operatively connected to said oscillating arm (6) by a cross lever (18), and a second end (16B) interacting with at least two electronic limit switches (19, 20) positioned at said two end positions (PL, PR).

2. The impulse sprinkler as claimed in claim 1, wherein said first end (16A) is operatively coupled to said cross lever (18) with a connection element (21).

3. The impulse sprinkler as claimed in claim 1, wherein said second end (16B) interacts with a third electronic limit switch (23) positioned adjacently to a centerline (Pc) of said end positions (PL, PR) and adapted to interrupt the automatic rotation of said spout tube (2).

4. The impulse sprinkler claimed in claim 1, wherein said actuator (16) is positioned on said spout tube (2) with a connection system (33) which is removable from said spout tube (2) or which is movable away from said oscillating arm (6) to disconnect said actuator (16) from said oscillating arm (6).

5. The impulse sprinkler as claimed in claim 3, wherein said adjustment system (15) comprises electronic control means (22) connected to said actuator (16) to allow an actuation thereof and a selective movement between said end positions (PL, PR).

6. The impulse sprinkler as claimed in claim 5, wherein said electronic control means (22) comprise at least one electronic compass (24) adapted to determine an instantaneous position of said spout tube (2).

7. The impulse sprinkler as claimed in claim 6, wherein said electronic compass (24) is positioned in correspondence with said substantially vertical axis (Z).

8. The impulse sprinkler as claimed in claim 6, wherein said electronic control means (22) comprise a Hall sensor (25′) and/or an encoder (25″) adapted to determine an instantaneous position of said spout tube (2) and correct any angular errors detected by the electronic compass (24).

9. The impulse sprinkler as claimed in claim 8, wherein said Hall sensor (25′) and/or said encoder (25″) interact with a ring (26) positioned in said rotatable joint (3) and provided with at least one magnet (27′) and/or one toothed surface (27″).

10. The impulse sprinkler as claimed in claim 6, wherein said electronic control means (22) further comprise a central microprocessor (29), a GPS sensor (30), and an electronic memory unit (28) adapted to store a value of the swinging angle (α) which can be set by a user or by an irrigation map.

11. The impulse sprinkler as claimed in claim 5, wherein said electronic control means (22) are connected to the pressurized water supply line to shut off a flow thereof when said third electronic limit switch (23) is active.

12. The impulse sprinkler as claimed in claim 5, wherein said electronic control means (22) further comprise a group of sensors (31, 32, 33) adapted to determine an instantaneous position of said spout tube (2), and wherein said group of sensors comprises one or more sensors selected from the group consisting of an accelerometer (31), a gyroscope (32), and a magnetometer (33).

13. A method for adjusting a swinging angle in an impulse sprinkler (1) according to claim 5, wherein the method comprises:
providing the impulse sprinkler according to claim 5;
storing in said electronic means (22) the swinging angle (α);
supplying the impulse sprinkler (1) with pressurized water;
positioning said actuator in a first one of the two end positions (PL) to control the rotation of said spout tube (2) in a first direction of rotation; and
monitoring an instantaneous position and the direction of rotation of said spout tube (2) in an angular sector (W) defined by said swinging angle (α) with said electronic control means (22).

14. The method as claimed in claim 13, wherein when the instantaneous position of said spout tube (2) reaches said swinging angle (α), a step is provided of positioning said actuator (16) in a second one of the two end positions (PR) opposite to the first end position (PL) to control the rotation of said spout tube (2) in a second direction of rotation opposite to the first direction of rotation.

15. The method as claimed in claim 13, further comprising a step f) of positioning said actuator (16) at a centerline of said end positions (PL, PR) when the swinging angle (α) is greater than the swinging angle that was set has been detected in the step of monitoring.

16. The method as claimed in claim 14, wherein, subsequently to said step of positioning step, there is provided a step of shutting off a flow of the pressurized water to shut off irrigation.
